(19) United States
(12) Patent Application Publication
(10) Pub. No.: US 2002/0029298 A1
(43) Pub. Date: Mar. 7, 2002

(54) Arrangement, a system and a method relating to management communication

(76) Inventor: Magnus Wilson, Jamjo (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/925,677

(22) Filed: Aug. 9, 2001

Related U.S. Application Data
(63) Continuation of application No. 09/027,738, filed on Feb. 23, 1998.

(30) Foreign Application Priority Data
Feb. 24, 1997 (SE) 9700654-8

(51) Int. Cl. G06F 9/00; G06F 9/46

(52) U.S. Cl. 709/316

(57) ABSTRACT

A system comprising a managing system and a number of managed systems, each comprising a number of managed objects, which managed systems are managed by said managing system. Via a number of mediating managed systems the managing system sends management operations addressing managed objects on a management interface. Management operations addressing managed objects not recognized, or not administrated, by the receiving mediating managed system are routed to another mediating managed system. The invention also relates to a mediating managed system including a routing functionality.

### BACKGROUND

The present invention relates to a system which comprises at least one managing system which manages a number of managed systems, which comprise managed objects representing resources, via a number of mediating managed systems. A management interface provides for communication between managing and managed systems and management operations addressing managed objects are sent on said management interface.

The invention also relates to an arrangement such as a mediating managed system for administrating a number of resources which are represented by managed objects and to which management operations are sent over a management interface. Still further the invention relates to a method of performing an operation on (a) managed object(s) in a managed system which is managed by a managing system which sends a management operation on a management interface which provides communication between a managing system and a number of managed systems.

Management of, for example, telecommunications networks is an area which requires more and more attention, among others because of the fact that the number of mobile telecommunication systems that exist which are based on different standards, different technologies etc. increase. Furthermore there is a continuous increase in the number of services which are provided and which are under development and the services are getting more and more advanced and complex. Since furthermore there are a number of different vendors of similar as well as of different products and a number of different operators, there are many actors on the markets. Specialized products are often required which are adapted for each specific system, even if the products as such support the same functionality etc.

One example is in the area of service management for mobile communication networks, such as for example GSM (Groupe Speciale Mobile), PCS (Personal Communication System), PCN (Personal Communication Network) etc. Since the telecommunication networks are getting larger and larger, as referred to above, a number of different managing systems, in this context denoted operations systems, for controlling the networks and the equipment of different vendors, are used, and the services in the networks are controlled in different ways, making operation and maintenance expensive and complicated. Therefore the concept of the telecommunications management network (TMN) has been defined. This is described in the ITU-T Recommendation M.3010. In the TMN view the telecommunications network is viewed by the operations systems over a standardized interface where all types of network equipment can be monitored and controlled in a similar manner. An example on an operations system is an administration system, for GSM such an administration system could be CAS (Customer Administration System). An operations system, or particularly a customer administration system, operates on a number of network elements over an interface. Particularly for subscription provisioning a device is often provided, which formulates a set of rules for presenting one uniform interface towards the customer administration system, the interface being denoted a customer administration interface, e.g. CAI which is CMISE-like and based on the GSM standard. Such a device which comprises a mediating managed system, or a mediating device, as is known within the TMN concept is advantageous in many aspects. It is among others simple to integrate with existing computer platforms. One known device uses communications standards such as e.g. TCP/IP and X.25. TCP/IP denotes Transmission Communications Protocol/Internet Protocol. A multi-session interface—one message, one response per channel is known which supports management interface service element services (CMISE), thus supporting actions such as creating, setting a value, getting a value from and deleting, a managed object, doing an action on a managed object, requesting a managed object to carry out a task etc. and also using filtering and scope evaluations to establish which managed objects are concerned etc. as also described in for example ITU-T Recommendation M.3010, ITU-T Recommendation X.710 etc. In the managed systems, here network elements, a number of managed objects (MOs) representing resources form the management view for the operations system, here CAS, and the physical location of the data, i.e. the resources that are represented by the managed objects, is hidden to the CAS by the mediating device.

A particular such mediating device is known which however is a GSM specific product and it does not support any other mobile communication standards. Furthermore the flexibility is limited in that it does not support a number of services, such as for example mobile intelligent network services. Even if the mediating device in other respects shows a high degree of flexibility, including multiple sessions wherein the operations system, here CAS, does not have to be aware about which physical server a channel resides on but only sees an address, the number of channels towards CAS from a performance point of view depend on the number of available connections to the managed network elements and the extendibility and scalability.of the device is limited.

One solution to some of these problems would be to copy the interface in other products but it suffers from at least one severe drawback, since it would require the administration system, or in more general terms, the operations system (OS), to know which mediating device handles which managed systems (or which network element) and also which network element functions (from TMN known as NEF). If the network is complex, for example including different services and different mobile standards, it would be extremely complicated as far as the administration system is concerned to provide for an integration towards the existing managed systems or particularly the network elements. Even worse, if load-sharing is applied through the use of more than one mediating device, the solution would be even more complex.

Thus, what really would need to be done, would be to provide for market adaptations for each customer. Thus most of the problems would still remain, the development of products would be expensive and the use would be inflexible.

### SUMMARY

What is needed is therefore a system comprising a managing system which manages a number of managed systems in which a number of managed objects represent a number of resources, the managed objects forming the management view to the operation system, via a number of mediating managed systems over a management interface which provides communication between the managing and managed systems, or a mediating managed system, wherein management operations addressing managed objects are sent over the management interface, through which management operations directed to managed objects can be performed irrespectively of whether the managed objects actually are comprised in the managed system which is managed, or administrated by a mediating managed system, receiving the management operation in a simple way and without requiring the managing system to be aware of which managed objects are administrated by which mediating managed system.

A system is also needed which allows a high degree of flexibility and through which different systems and standards or networks can be managed in an easy way, including a high performance, extendibility and scalability and in which mediating managed systems, or more generally arrangements receiving operations, easily can be added in a simple way, advantageously without affecting other mediating managed systems acting as receiving arrangements of management operations. Particularly the other mediating managed systems are only provided with information that a new mediating managed system or a new functionality has been added; particularly they do not even have to be informed that another functionality has been introduced so that another system can be managed by the managing system.

A system is also needed through which a managing system, or particularly an operations system, does not have to be aware of which mediating managed system handles which managed systems or which managed system functionality.

A mediating managed system acting as a receiving arrangement for management operations is also needed through which the above mentioned objects can be achieved.

Still further a method of performing an operation on a number of managed objects in a managed system, which is managed by a managing system sending a management operation on a management interface which provides for communication between managing and managed systems, is needed, through which the operation can be performed on the addressed managed objects, irrespectively of whether the managed objects actually are managed or administrated by a mediating managed system receiving the management operation, in a simple way and without the managing system having to be aware of which mediating managed systems, i.e. receiving arrangements, manage or administrate the addressed managed objects and wherein the management interface not only supports communication between a managing system and a mediating managed system, or a managed system, but also supports communication between a number of mediating managed systems.

According to the invention, a management operation which is received in a mediating managed system (or a managed system comprising a mediating functionality) which addresses one or more managed objects which are not recognized by, or administrated by, the receiving mediating managed system (or the managed system including mediating functionality) is routed to at least one other mediating managed system (or a managed system including a mediating functionality).

This routing can be done in different ways. According to one embodiment the routing from one mediating managed system (or managed system including a mediating functionality; in the following it will only be referred to as a mediating managed system although it can also be a managed system including such a functionality) to a neighbouring mediating managed system, or some other mediating managed system with which the receiving mediating managed system communicates via the management interface, in a consecutive way until a mediating managed system is found which recognizes the managed objects to which the operation is directed, or which administrates the managed objects which are addressed.

In one embodiment the routing is done in any order until the mediating managed system, which is searched, is found. In an alternative embodiment the routing is done in a controlled manner. In the latter case the receiving mediating managed system keeps information about which mediating managed systems administrate which managed objects, so that the operation can be routed to said mediating managed system, either directly, or via a given route.

In still another embodiment only some of the mediating managed systems keep information about which managed objects are administrated or managed by a given mediating managed system, in that case the operation is directed for example to neighbouring mediating managed system until such a mediating managed system is found, which then routes the operation in a controlled manner.

Particularly one mediating managed system administrates a number of managed objects, or one or more managed systems, and/or one or more function blocks, within a number of managed systems. Still further, particularly a managing system is not aware of to which mediating managed system a management operation is sent and/or routed.

In a particular embodiment each mediating managed system provides access (by the managing systems) to all the functionalities, or any managed objects, supported by the totality of managed systems.

As referred to above, a mediating managed system at least keeps information about which managed objects are comprised in the mediating managed system itself and the managed objects that are comprised in managed systems administrated by said mediating managed system. However, as also referred to above, mediating managed system can also keep information about which mediating managed system administrates, or comprises, some of, or all, the other managed objects of the system.

One or more mediating managed systems may be instructed to reject operations which are not recognized. If no mediating managed system is found which recognizes the MO:s addressed by the operation, the operation may also be rejected.

Each managed object is given a distinguished name, which is unique within the system, and at least one instance name, which is unique within the managed system to which it belongs, or rather in which it is comprised, as a representation of the resources of the managed system. The distinguished name comprises the instance name and the name, or the address, of the managed system. Each mediating managed system comprises a detecting and routing function, in the following denoted a distinguished name function (DNF), and for finding the address of a managed system, the instance name within that managed system is used.

In an advantageous embodiment the routing functions (DNF) of all the mediating managed systems keep information about all managed objects or all managed object instances of the system. The information must then be kept consistent throughout the system, i.e. kept consistent within the totality of mediating systems. Particularly does information here mean information about the “location” of the managed object instance.

According to one embodiment, if an operation addresses a managed object which can not be identified by the receiving mediating managed system, the management operation is rejected and returned to the sending system, which, if it is a managing system, comprises the transmission of a notification.

In an advantageous embodiment, a new, or an additional, mediating managed system can be added to the system without requiring any changes or updates of the other mediating managed systems. However, advantageously the, or at least some of, the other mediating managed systems are provided with information that a mediating managed system has been added. However, if all mediating managed systems keep information about all managed objects of the system, they are provided with such information for example to enable controlled routing to such new mediating managed system. Particularly each mediating managed system comprises an agent, for each of a number of types of managed objects managed or administrated by said mediating managed system, via which the managed objects are manipulated by the managing system. Particularly there is one agent for each type of managed object.

A number of mediating managed systems can be arranged in one and the same hierarchical layer, but mediating managed systems can also be arranged in different hierarchical layers. For example one mediating managed system can be a superior mediating managed system to a number of sub-ordinate mediating managed systems and vice versa. In a most advantageous embodiment the routing function supports at least two routing alternatives, such as for example a primary and a secondary route, to another mediating managed system, or to a number of other mediating managed systems, so as to provide for redundant ways in case of a link failure or some other mal-functioning.

Advantageously is also provided for load-sharing between mediating managed systems. This is provided through a routing function (DNF) which not only recognizes the types of the managed objects, but which also allows instance information about managed objects to be used in combination with managed object type information for the selection of an appropriate agent. In an advantageous embodiment the system relates to a telecommunications management network (TMN), wherein the managing system(s) comprise(s) operations systems (OS), the managed systems comprise network elements (NE), and the mediating managed systems comprise mediating devices (MD). A mediating device may either comprise a network element or it may be used as a network element protocol.

In an advantageous embodiment the management interface supports common management information service elements, i.e. common management information services (CMISE). CMISE is discussed in ITU-T (formerly CCITT) Recommendation X.710, which hereby is incorporated herein by reference.

Each mediating device comprises an agent for detecting and routing functionality. Advantageously it also comprises agents for one or more network elements or types of managed objects. Examples on network elements are home location register (HLR), mobile switching center (MSC), equipment identity register (EIR), authentication center (AUC) etc. It should however be clear that these are only examples given for exemplifying reasons.

In an advantageous embodiment the system comprises mediating devices dedicated for a number of different telecommunications systems, such as for example the devices for one or more of GSM, NMT, ADC, PDC, DECT, D-(AMPS) etc.

In an advantageous embodiment the managing system, or the operation system, is an administration system, such as for example a customer administration system (CAS), and the management interface comprises a customer administration interface (CAI) including the extended functionality providing for intercommunication between mediating devices.

A mediating managed system is therefore also provided for administrating a number of resources represented by managed objects MOs to which MOs management operations are sent over a management interface. The mediating managed system comprises a function for routing incoming management operations addressing managed objects which are unknown to, or not administrated by, said mediating managed system to another mediating managed system. The mediating managed system functions as the mediating managed systems described above with reference to the system including among others such a mediating managed system and includes any of the functionalities described above. Advantageously the routing function at least comprises a table of managed objects comprised in, or administrated by, the mediating device. The routing function may comprise information about types of managed objects, and in an advantageous embodiment also managed object instance names. In an advantageous embodiment the routing function also comprises information about a number of other managed objects (e.g. in which managed system they are comprised), and a controlled routing can be performed for operations, directed to such managed objects, to another mediating managed system administrating such managed objects.

A system is also provided which includes a number of mediating systems, as referred to above, which mediating systems are interconnected so as to form a network of mediating managed systems and wherein the management interface providing for communication between a managing system and said mediating systems further comprises the additional functionality of providing communication between the mediating managed systems, which management interface advantageously supports CMISE services.

Therefore it is also provided for a method of performing an operation on a number of managed objects comprised in managed systems which managed systems are managed by a managing system which sends a management operation over a management interface, said interface thus providing communication between a managing system and a number of managed systems, which method comprises the steps of; receiving an operation in a mediating managed system; examining if the managed objects addressed by the management operation are comprised in the mediating managed system or in a managed system administrated by said mediating managed system; if yes, performing the management operation on the addressed managed objects and if not, routing the operation to another mediating managed system.

In said other mediating managed system is examined if the managed objects are comprised therein or administrated thereby in which case the management operation is performed on the managed objects and, otherwise, the management operation is sent on to another mediating managed system.

This can be done in a controlled manner, for example if a receiving mediating managed system keeps information about which managed objects are managed by which mediating managed systems, or it can be done in an investigating manner (arbitrary or according to given routes) until the appropriate mediating managed system is found. If no such mediating managed system is found, the operation can be returned to where it came from or a notification can be sent to the managing system.

A method of adding a mediating managed system to a system including a number of mediating managed systems managed by a managing system, is also provided, through which the mediating managed system is added without requiring updating of the other mediating managed systems, although the other mediating managed systems, or some of them, can be provided with information that such a mediating managed system has been added according to one embodiment, and providing for communication between the added mediating managed system and the other mediating systems over management interface having the extended functionality of providing communication also between mediating managed systems.

### BRIEF DESCRIPTION OF THE DRAWINGS

The invention will in the following be further described, in a non-limiting way, with reference to the accompanying drawings in which:

FIG. 1 for explanatory reasons shows the communication between a managing system and a managed system,

FIG. 2A schematically illustrates a managing system which manages a number of managed systems via a mediating managed system,

FIG. 2B schematically illustrates a managing system managing a number of managed systems via a managed system comprising a mediating functionality,

FIG. 2C schematically illustrates still another example of a managing system managing a number of managed systems using a mediating functionality,

FIG. 3A schematically illustrates a network element comprising mediating functions and network element functions,

FIG. 3B schematically illustrates a mediating device controlling two network elements,

FIG. 4 illustrates one embodiment of the invention in which communication is provided between a number of mediating managed systems,

FIG. 5A schematically illustrates one embodiment of the invention in which the mediating managed systems comprise mediating devices controlled by a customer administration system,

FIG. 5B illustrates a distinguished name function table for one of the mediating devices in FIG. 5A,

FIG. 5C shows a distinguished name function table in the other mediating device of FIG. 5A,

FIG. 6A shows one embodiment in which an administration system manages a mixed network via a number of mediating devices,

FIG. 6B is a table of a distinguished name function in a first mediating device of FIG. 6A,

FIG. 6C shows a table as in FIG. 6B, but for a second mediating device of FIG. 6A,

FIG. 6D is also a table as in FIG. 6B, but for a third mediating device of FIG. 6A,

FIG. 7A shows an embodiment comprising a redundant configuration,

FIG. 7B is a table of a distinguished name function of one of the mediating devices of FIG. 7A,

FIG. 7C is a distinguished name function table as in FIG. 7B, but for another mediating device of FIG. 7A,

FIG. 7D is a table as in FIG. 7B, but for still another mediating device of FIG. 7A,

FIG. 8 is a schematical example of a number of mediating devices arranged in a hierarchical structure for a mixed tele-communications network,

FIG. 9 shows an example of mediating devices for a mixed communication system, which are arranged in a flat structure, and

FIG. 10 is a flow diagram illustrating, in a schematical manner, the handling of a management operation incoming to a receiving mediating managed system.

### DETAILED DESCRIPTION

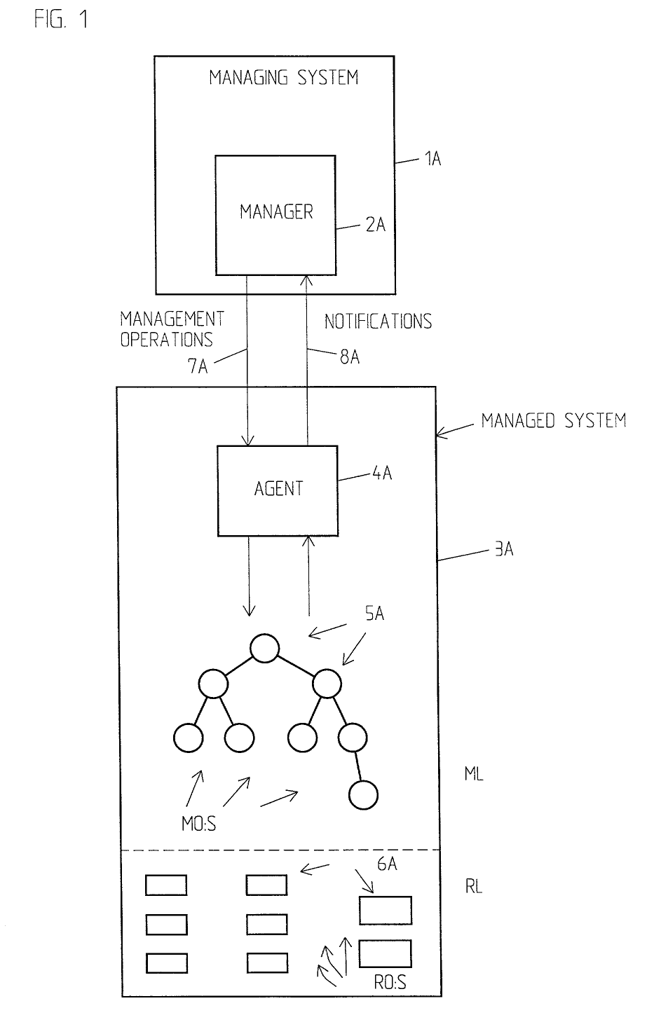

In FIG. 1, for explanatory reasons, the management communication between a managing system 1A and a managed system 3A is illustrated. In the managed system 3A a number of managed objects 5A (in the following also denoted MOs) are formed to make up the management view towards the managing system 1A. The managed objects 5A represent resources, here denoted resource objects (ROs)6A. The managed system 3A is divided into a management layer ML containing the managed objects 5A and a resource layer RL containing the resource objects 6A. Only the managed objects 5A can be monitored and controlled, or managed, from the managing system 1A. In for example the telecommunications management network TMN, standardized managed objects are provided for most applications. The resources can be of different kinds, such as physical resources, logical resources or functional resources.

There does not have to be one managed object for each resource but a number of managed objects can be implemented as one resource. Each managed object then provides a different management view of the resource. There is a wide variety in the mapping between managed objects and resources. For example one or more managed objects can represent different views of one resource, a managed object can represent a combination of resources but a managed object can also represent other managed objects.

The managing system 1A comprises a manager 2A which manipulates the managed objects 5A in the managed system 3A via an agent 4A in the managed system 3A. The manager 2A establishes an association, which can be seen as a communication link, to the agent 4A of the managed system 3A and when this association is set up, the manager 2A and the agent 4A can communicate. The manager 2A manipulates the managed object 5A using a number of defined operations such as create a managed object, delete a managed object, set a value in a managed object, get a value from a managed object and an operation known as an action, i.e. doing an action on a managed object or making a managed object do an action. The managed objects 5A generate notifications which can be forwarded as event reports to the managing systems 1A; this is however not part of the present invention. The managing system 1A sends management operations 7A via its manager 2A to the agent 4A of the managed system 3A. In the telecommunication management network (TMN) referred to earlier in the application, (c.f. also CCITT Recommendation M.3010, which hereby is incorporated herein by reference), the management systems 1A comprise operation systems whereas the managed systems comprise network elements. The operations and event reports are parts of the common management information service (CMISE).

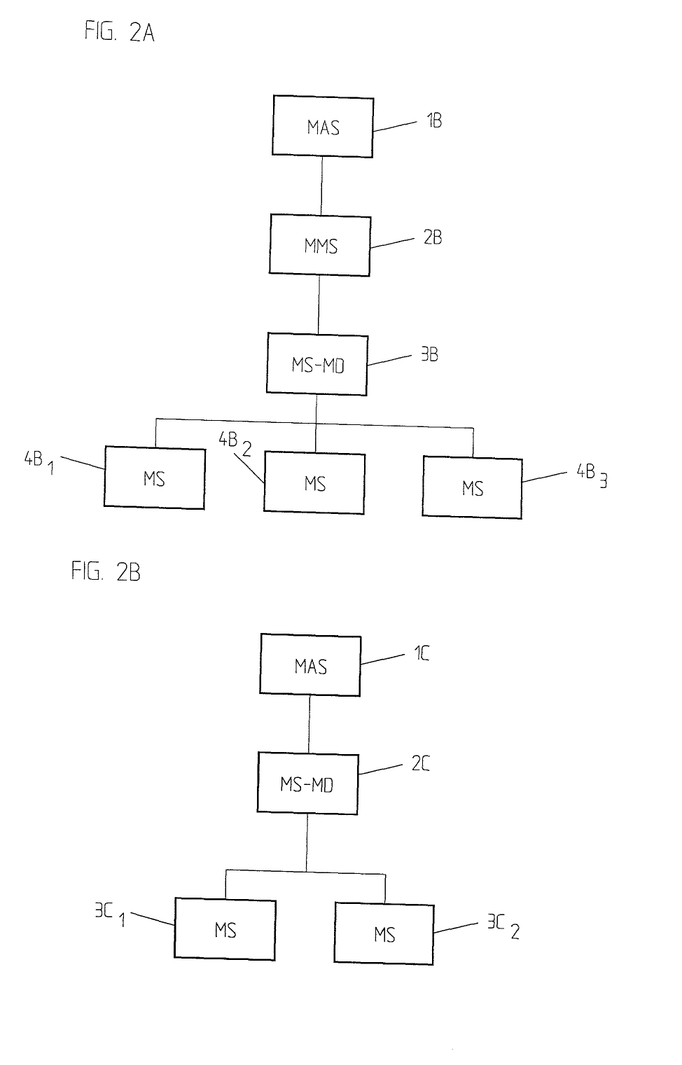

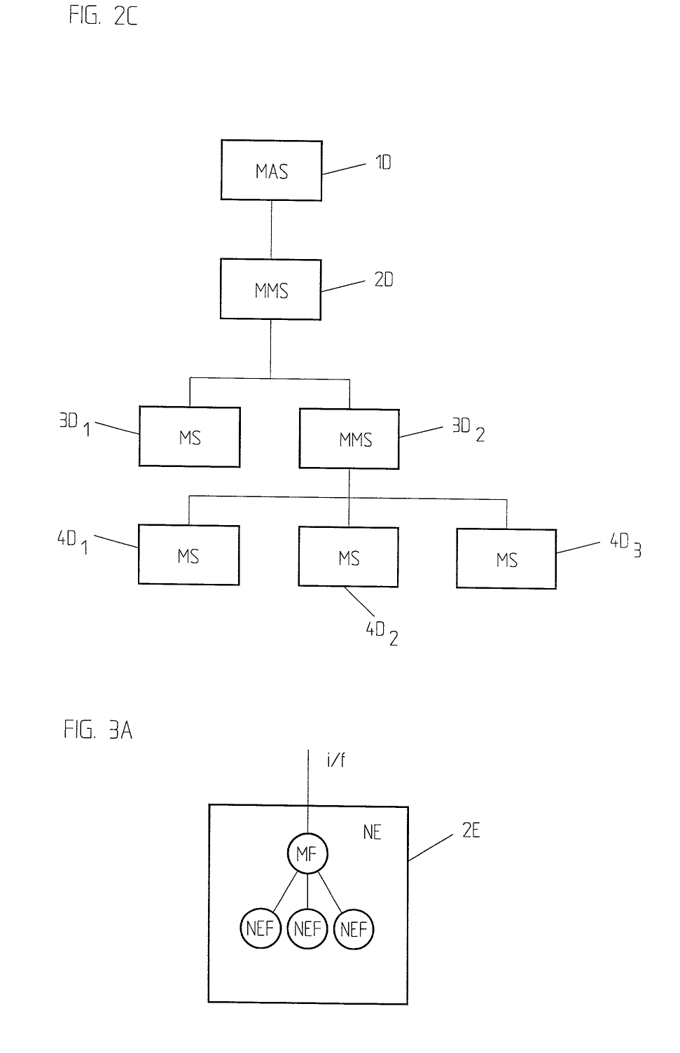

In FIG. 2A a managing system (MAS) 1B manages a number of managed systems (MS) 4B₁, 4B₂, 4B₃ via a mediating managed system 2B and a managed system including a mediating functionality 3B. In the present invention mediating managed systems are also managed systems and they contain a number of managed objects. Furthermore they control a number of managed systems. A managed system can also be provided with a mediating functionality. Mediation is a process which is known from the TMN concept and it is also discussed in the Recommendation M.3010 as referred to earlier in this application. In TMN mediation is a process which acts on information passing between network elements functions and operations systems functions (among others) and it provides a local management functionality to the network element or the network elements. Mediating managed systems are then called mediating devices as will be discussed further below. In general mediation relates to two functionalities, namely to provide management functionality to groups of similar network elements or to provide management functionality to one network element.

In FIG. 2B a managing system 1C manages two managed system 3C₁, 3C₂ via an intermediate managed system 2C (here denoted MS-MD) which thus is a managed system including a mediating functionality. Of course a number of other alternatives are possible and the number of managed system is of course not limited to two, but there can in principle be any number. This also applies to FIG. 2A and to any other figure herein.

In FIG. 2C still another example is illustrated relating to how the systems can be arranged. Here a MAS 1B manages a number of managed systems 3D₁, 4D₁, . . . , 4D₃ via a mediating managed system 2D which in turn also controls another mediating managed system 3D₂ arranged in a lower hierarchical layer and which in turn controls the managed systems 4D₁, 4D₂, 4D₃, (also here it could have been any number of managed systems as discussed above).

In FIG. 3A a managed system in the form of a network element (NE) 2E is illustrated which includes a mediating functionality (MF) and a number of network element functions (NEF).

FIG. 3B shows a mediating managed system in the form of a mediating device (MD) 2F comprising a mediating function MF which controls the network element functions NEF in the network elements 3F₁, 3F₂. FIG. 3A and 3B thus show the alternative cases in which a managed system or a network element includes both a mediating functionality and the network element functions (NEF) and the case of a mediating device controlling the network element functions of two network elements.

FIGS. 1-3 are shown in order to illustrate some examples on how the inventive concept can be implemented and varied.

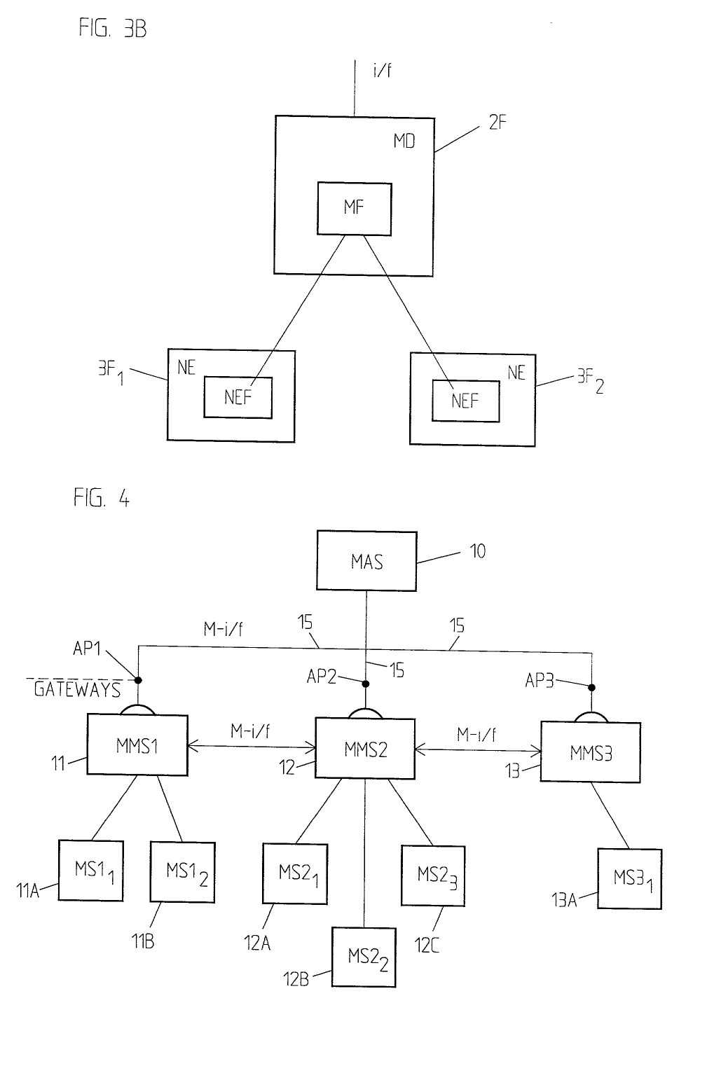

In FIG. 4 a managing system (MAS) 10 can send management operations on management interface (M-i/f) 15 to a number of managed systems 11A, 11B, 12A, 12B, 12C, 13A via the mediating managed systems MMS1 11, MMS2 12, and MMS3 13. Thus the managing system 10 controls the mediating managed system 11, 12, 13 which in turn controls the managed systems 11A, 11B, 12A, 12B, 12C; 13A. The access points AP1, AP2, AP3 are identical from the point of view of the MAS 10 and in each AP it is advantageously possible to access all the functionality as provided for by the collection of MMSs (with maintenance of protocol characteristics). The invention, however, also can be applied in such a way that not all access points, but a number of them, are identical as viewed from MAS, e.g. in very large systems.

The managing system 10 thus controls managed objects in the managed systems. The managed objects are not illustrated and the mediating managed systems 11, 12, 13, in the following denoted MMS1, MMS2 and MMS3 respectively each control or administrate a number of managed systems. Thus MMS1 11 administrates managed systems MS₁, MS₂ 11A, 11B. MMS2 controls MS2₁ 12A, MS2₂ 12B, MS2₃ 12C and finally MMS3 controls MS3₁ 13A. According to the invention the management interface 15 comprises the extended functionality so as to also enable the handling of managed objects which are not recognized by the receiving mediating managed system. Thus, if for example MMS1 11 receives a management operation addressing a managed object for example in MS2₂ 12B administrated by MMS2 12, the operation is transferred from MMS1 11 to MMS2 12 wherein an analyze takes place and wherein it is established that MS2₂ 12B is the managed system comprising the addressed managed object, and then the operation is sent to MS2₂ and performed in a manner known per se. The mediating managed systems can be said to be arranged so as to form a distributed configuration. According to this concept each access point should be identical when seen from the point of view of the MAS as referred to above. In each access point, or via each mediating managed system, it is possible to access all functionality as provided by the total collection of mediating managed systems under maintenance of all protocol characteristics. The extended management interface thus is not only used as an interface between the managed system and the mediating managed system, but it is also used as an interface between a number of mediating managed systems and it is basically used as a managed system protocol or the mediating managed systems are defined as a managed system. By interconnecting multiple mediating managed systems it is no longer required that each mediating managed system is capable of handling all the functionality as required by the managing system. For example each mediating managed system can be specialized in a specific area. Each mediating managed device can e.g. be specialized for a specific mobile communications system such as NMT, GSM etc. From a logical point of view, a customer will however not perceive the mediating managed systems, or particularly the mediation devices, but will rather perceive them as one mediating managed system (or mediation device) supporting all the needs of the customer.

Advantageously specific or new areas of functionality can be introduced. In an advantageous embodiment a mediating managed system or mediation device for mobile intelligent network (MIN) services is provided. Since the mediating managed systems will only pass management operations directed to MIN MO:s (managed objects) to the mediating managed systems for MIN services, a particular MIN mediating managed system, or particularly a mediation device, is developed using the particular parameters and services that are needed without requiring any coordination with the other mediating managed systems. If then (according to one specific embodiment) a management operation addressing MIN MO:s is sent from a MAS (e.g. CAS) and received in another mediating managed system than the one controlling MIN MO:s, the receiving mediating managed system (MNS) sends the operation to another MMS using default routing which in turn sends it on until the MMS (e.g. newly added) is found.

According to one embodiment new types of managed systems, particularly network elements, can be integrated directly through a mediation device without changing existing products and network structure through the implementation of the distributed configuration in the network element. The invention thus solves the problems of product coordination. Mediating managed systems can be added in principle anywhere, in a distributed configuration, e.g. in any hierarchical layer or anywhere in a flat structure, which makes the system extremely flexible and a network can be built out or enhanced in any manner.

Each managed object MO is given an instance name when it is created. All managed objects which are “children” of the same managed object have different instance names. The instance name does not have to be unique within the managed system but two managed objects can have the same instance names on condition that they have different “parent” managed objects. Since in some managed systems or particularly network elements, the number of managed objects can be very high, they are arranged in a so called naming tree structure. The standards define a management information tree (MIT) structure or a naming tree. One managed object that is situated immediately below another managed object in the MIT is called its sub-ordinate, whereas a managed object immediately above it is called its superior managed object. However, every managed object also has a name that is used to identify it, which is unique within the whole managed system and which is called a distinguished name DN. The distinguished name starts from the root of the MIT and ends with an instance name of the managed object. Thus each MO (and instance) has a unique name comprising its representation in the network (the management information base (MIB) which is the model of the network to the mediating managed system. In a simplified manner the distinguished name DN can be said to comprise two parts, namely the instance name, which is the unique identity within the particular managed system, and the address of the managed system. A mediating managed system uses the MO instance name to find the managed system address, thus hiding the physical implementation from the managing system. According to one embodiment an MO has more than one instance name (one example thereon is, for mobile telecommunication systems, home location registers, wherein a first instance name may be the MSISDN and a second instance name may be the IMSI-code. MSISDN is the mobile station ISDN (Integrated Services Digital Network) number which uniquely identifies a mobile telephone subscription in the public switched telephone network numbering plan and IMSI is the International Mobile Subscriber Identity. Conversion methods can be provided for going from one instance name to another.

According to the invention the management interface is thus extended in that it comprises a routing checking functionality, in the following denoted the distinguished name function DNF. DNF has the functionality to detect whether a particular MO can be handled by the particular mediating managed system or if it has to be sent to another mediating managed system which recognizes it or which can interpret it. The DNF comprises a list of all recognized MOs. If an operation addressing an MO is received which is not known to DNF, one of two actions can be taken, namely the operation can be rejected and sent back to the originator with a message indicating for example “unknown MO instance”. Alternatively the operation is re-routed to a default mediation managed system for execution. If the first approach is used, the DNF lists, particularly tables, have to be consistent within the collection of mediating managed systems. The second approach can e.g. be used if a new function such as a mediating managed system is added to a network. The existing DNF tables would then not have to be updated. Alternatively a combination of both approaches is used.

Still further a number of MMS:es can be provided with information or keep information about MO:s of one or more other MMS:s, in which the routing is done in a controlled manner, at least in part.

According to the invention each mediating managed system comprises an agent for the DNF functionality. In addition thereto, in a mediating managed system each MO type (of the MOs administrated thereby) is connected to an agent in order to enable the execution of the requested action on the MOs. The DNF agent comprises the routing functionality. In an advantageous embodiment, as will be further discussed below, this agent supports more than one routing alternative such as for example a primary and a secondary route to provide for redundancy. In this way a safe and reliable connection to all managed systems is provided and the flexibility of the distributed configuration is considerably increased.

In another advantageous embodiment load-sharing is provided between mediating managed systems. The DNF then, in addition to recognizing MO types, also allows MO instance names to be used in combination with MO types when an appropriate agent is selected. In this way both the available managed system resources and the mediating managed system processing resources are utilized in an efficient manner. Managed systems with intensive transaction rates can then be evenly distributed over several mediating managed systems. Advantageously such a configuration is selected and decided upon at runtime and not at the development stage, which still further increases the flexibility and the scalability of the system.

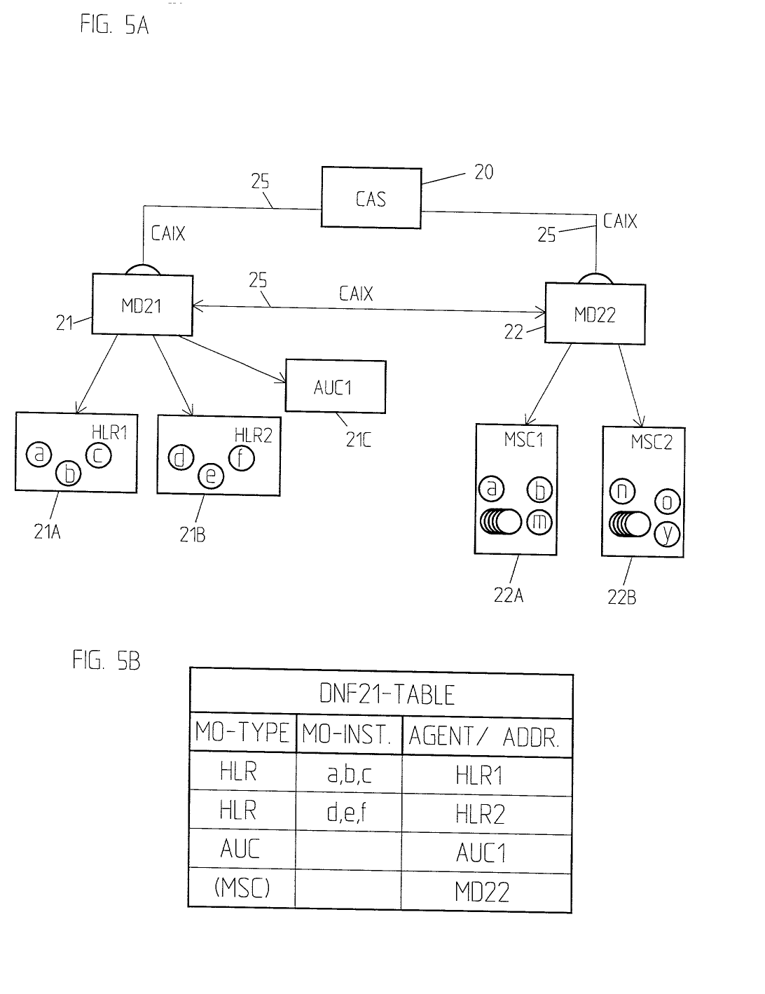

In FIG. 5A a system is illustrated comprising a managing system in the form of a customer administration system CAS 20 which manages a number of managed systems, here being a home location register HLR1 21A, HLR2 21B, an authentication center AUC1 21C, mobile switching centra MSC1 22A and MSC2 22B, via a mediating device 21 and a mediating device 22. The management interface is a customer administration interface with an extended functionality, CAIX 25, thus providing for communication also between the mediating managed systems MD 21 and MD 22. As referred to above each MD comprises a DNF agent and one agent for each MO type. These agents are however not shown in the figure for reasons of clarity. HLR1 21A comprises the managed objects a, b, c, HLR2 21B comprises the managed objects d, e, f and MSC1 22A comprises the managed objects a, b, . . . , m and MSC2 22B comprises the managed objects n, o, . . . , y. For example FIG. 5A relates to a small mixed network (e.g. less than 500 000 subscribers) and MD21 may for example illustrate a mediating device (MD) for GSM and MD22 may comprise a NMT-MD. These are of course only examples given for explanatory reasons. As referred to above each MD comprises a DNF which comprises lists of recognized managed objects. In FIG. 5B a DNF table relating to MD21 is illustrated. As can be seen from the table, the MO types HLR comprising the managed object instances a, b, c and d, e, f respectively have the managed system addresses, (here network elements), HLRl and HLR2 respectively. The NE address of MO type AUC is AUC1 and MOs of type MSC are no administrated by MD21 but known by MD21 as being administrated by MD22, which thus is given as the address.

In order to illustrate another embodiment MSC is written within brackets. This shows the case, i.e. MSC is not included on the list, when default routing is used, i.e. if an operation is received which addresses unknown MO:s, it is routed to MD22. For similar reasons AUC and HLR in the table of FIG. 5C are provided with brackets and if they are not known, operations addressing MO:s of this type are routed to MD21.

In FIG. 5C the corresponding DNF 22 table is illustrated and it is built in a corresponding manner. As can be seen AUC MOs are not administrated by MD22 but by MD21 which is given as the address. Managed objects of type HLR are likewise administrated by MD21. MD21 and MD22 (e.g. GSM-MD and NMT-MD) can be developed and handled as two completely different products and either of the systems can be updated without interfering or affecting the other system, resulting in a high availability and degree of modularity to the operator. Furthermore testing of new functionalities in either of the systems can be done without requiring retesting of the other system and a completely new product can be marketed, or alternatively an enhanced functionality can be sold. For example it is possible to start with one of the networks and introducing an MD for the other network at a later stage, but also still another MD of another system or functionality at another time etc.

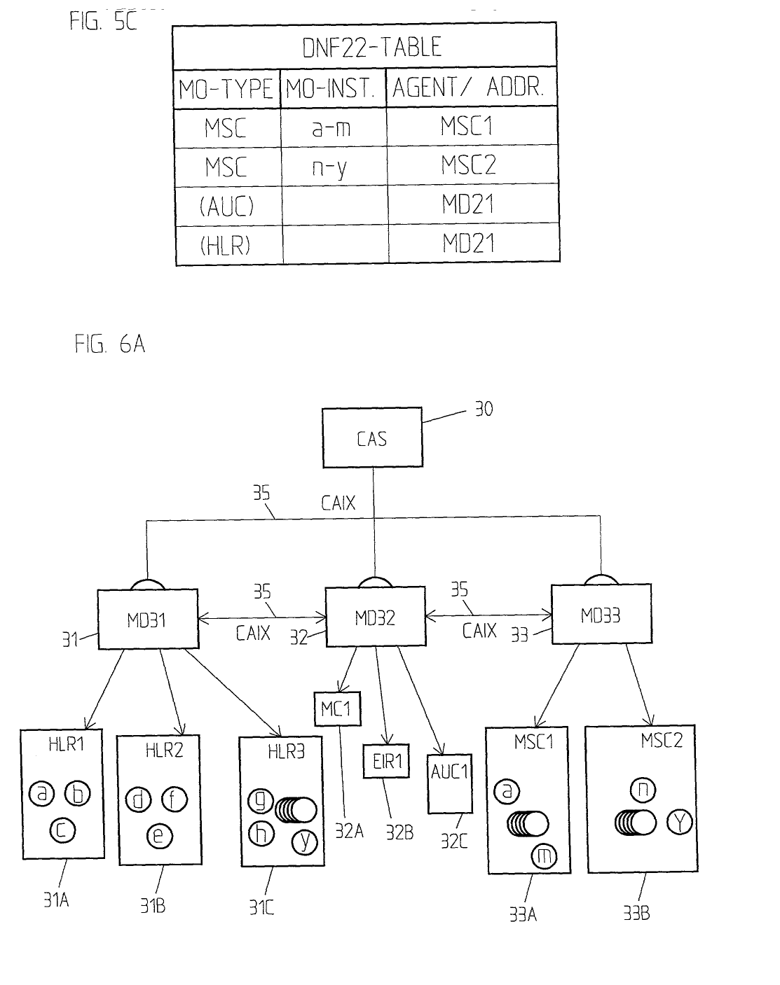

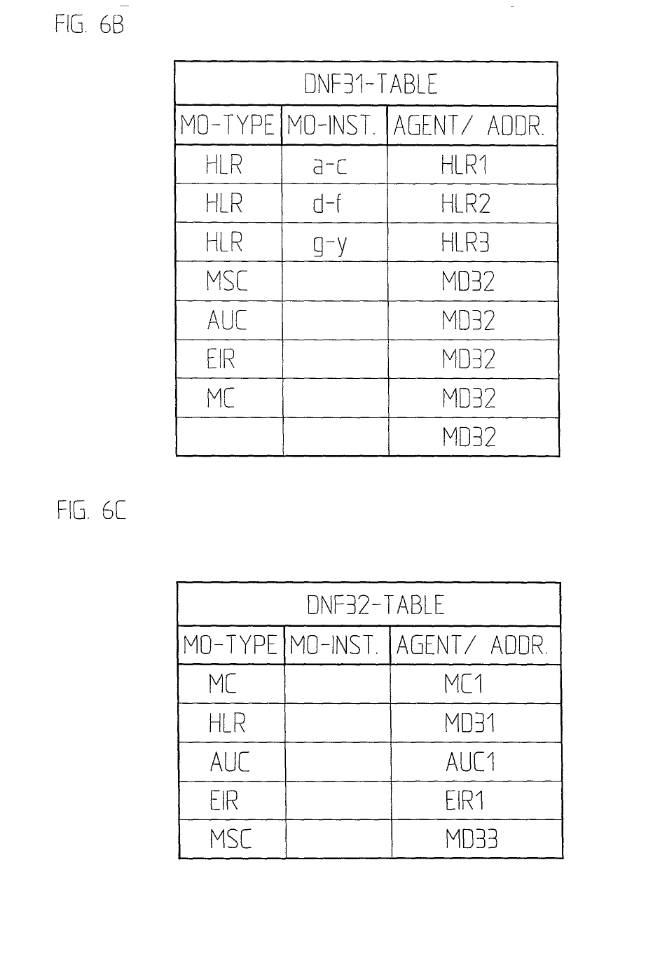

In FIGS. 5A-5C some cases of controlled routing are illustrated. This will be further discussed with reference to FIGS. 6A-6D. However, the tables can keep information on what to do if operations are received which address unrecognized MO:s. For example, if MO:s of given kinds or MO instances of given kinds are addressed, they can systematically be directed to e.g. MD22 (if received in MD21) without MD21 knowing anything about which MD actually controls them. Still further, any MO which is addressed, but not known, can be routed to e.g. MD22. Then the MD just sends any operation on which does not address its “own” MO:s.

In FIG. 6A still another embodiment is illustrated, also in this case relating to a customer administration system 30 managing a number of network elements 31A, 31B, 31C, 32A, 32B, 32C, 33A, 33B via mediating devices MD31, MD32, MD33 using an extended customer administration interface CAIX35. According to this embodiment a bigger mixed network is shown, also here it relates, for exemplifying reasons, to GSM and NMT. MD31 is a GSM-MD administrating HLR1, HLR2, HLR3. MD32 is a GSM-MD administrating a messaging center, an equipment identity register and an authentication center. Thus a separate mediating device 32 is added to handle messaging center traffic and in this particular case also low intensity traffic such as EIR and AUC traffic. It should however be clear that this only relates to a particular embodiment and there are of course no particular reasons why MC traffic, EIR traffic and AUC traffic should be administrated by a separate MD; any combination is in principle possible. MD33 here comprises an NMT-MD. HLR1 comprises here managed objects a-c, HLR2 comprises MOs d-f, HLR3 comprises MOs g-y and MSC1 comprises MOs d-m and MSC2 comprises MOs n-y. FIGS. 6B-6D show, in a manner similar to that of FIGS. 5B and 5C, the DNF tables for MD31, MD32 and MD33 respectively. However, the last row in FIG. 6B illustrates that operations addressing MO:s (or MO instances), which are not recognized when the analyze in MD31 is done, are systematically routed (default routing) to MD32. In an alternative embodiment (not shown) address information is only kept for MO:s controlled via the receiving MD itself. Then may e.g. all operations addressing such MO:s be sent to another MD or the neighbour MD. More generally, the MD keeps information about where to send unrecognized MO operations.

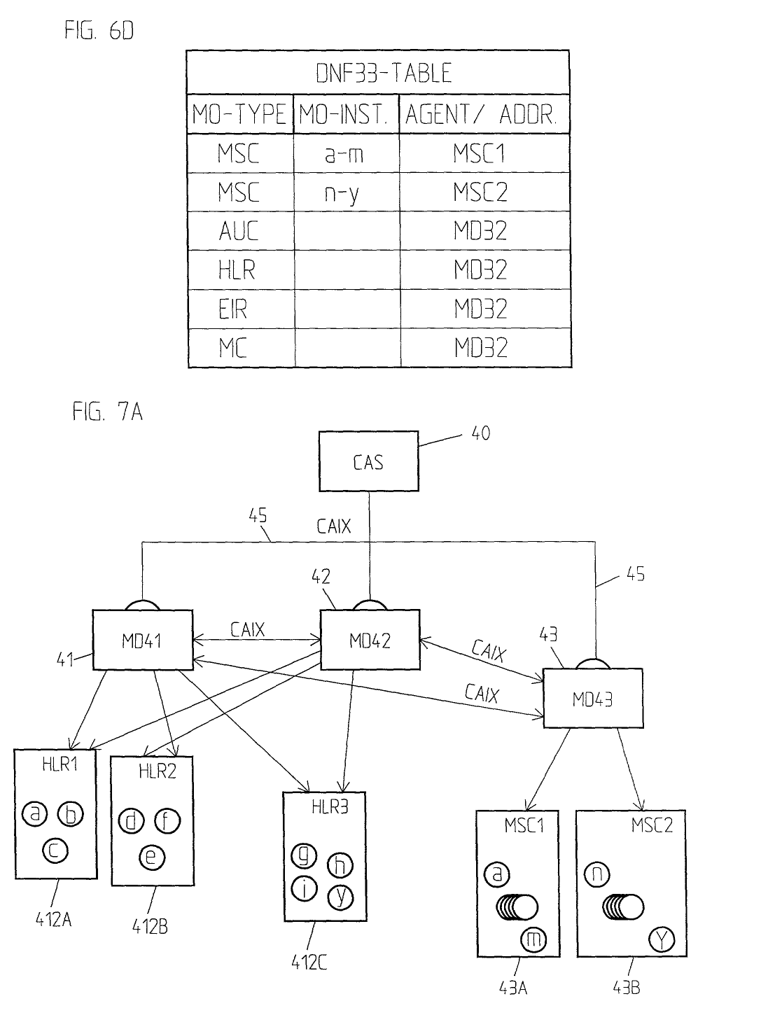

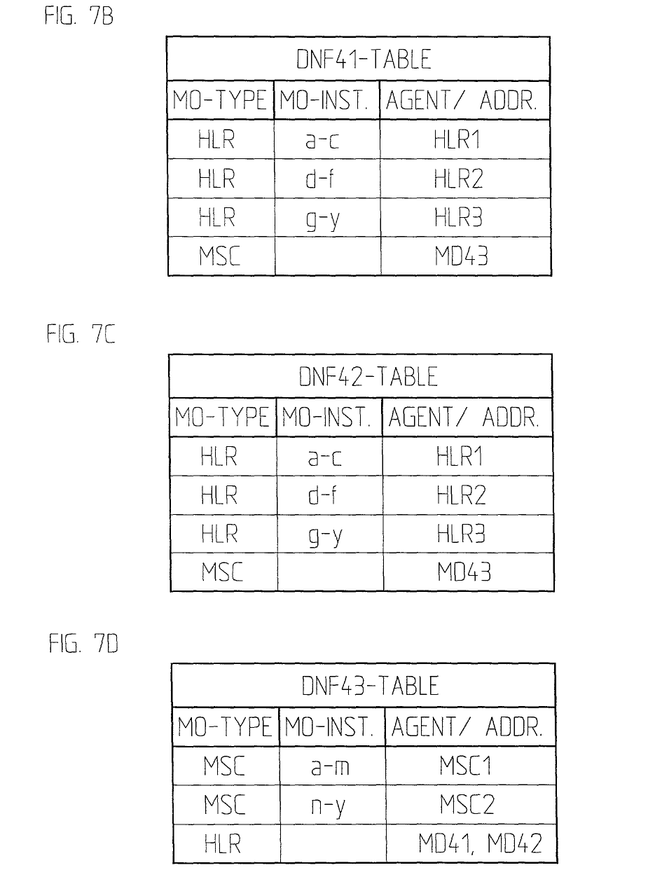

In FIG. 7A an embodiment is illustrated in which redundancy is provided. CAS 40 manages HLR1 412A, HLR2 412B, HLR3 412C, MSC1 43A and MSC2 43B via mediating devices MD41, MD42, MD43. The extended management interface CAIX45 here provides for communication between neighbouring MDs, MD41 and MD42, MD42 and MD43 respectively but also between MD41 and MD43. For reasons of simplicity no other network elements than home location registers are illustrated. Also here it is supposed that MD41 and MD42 relate to GSM whereas MD43 relate to NMT; CAS 40 is here aware of all three mediating devices or access points with their unique addresses and in the case of access problems towards one mediating device, for example due to link failure etc., CAS 40 is able to re-route traffic to another MD or to another access point.

In FIG. 7B the DNF41-table is illustrated being the DNF-table of MD41. MO instances a-c of type HLR have NE-address HLR1, MO instances d-f also of HLR-type have NE-address HLR2 and MO instances g-y also of type HLR have NE-address HLR3. MOs of type MSC have address MD43.

In FIG. 7C the DNF42-table of MD42 is illustrated. In this case it is identical with the DNF41-table. The instance information of the MOs in HLRs 412A, 412B and 412C is here thus contained in both MD41 and MD42.

FIG. 7D shows the DNF-table, DNF43 of MD43. As can be seen from the table, management operations directed to managed objects of type HLR can be directed either to MD42 or to MD43.

Although, with reference to FIGS. 5A-7A, the mediating managed systems have been illustrated as comprising mediating devices of GSM and NMT, it should be clear that it could also have been other mobile communications systems, such as for example (D)-AMPS, ADC, PDC, PCN, PCS, private branch exchanges PBX, DECT etc. They may also relate to particular functionalities and act as mediating managed systems for any managed system which is managed by a managing system (which of course does not have to be a customer administration system but which can be any other operations system or managing system in general; the principle remains the same).

Mediating devices may also comprise mediating devices for integrated complex mobile intelligent network services and comprise mediating devices for generic service adapters for intelligent network services, service management application systems and large integrated complex MIN services comprising a number of mediating devices for service management applications.

It is also possible to introduce new types of managed systems, or particularly network elements, e.g. add a new home location register which e.g. is to be included in the standard set at a later time.

In a particular embodiment smart mediation devices can be added which present a new functionality (i.e. comprise new MOs) through a combination of already available MOs. One example thereon relates to creation of one MO for a mobile subscription comprising several other MOs such as subscriberInHLR, subscriberInAUC, email, faxmail, personalNumber etc.

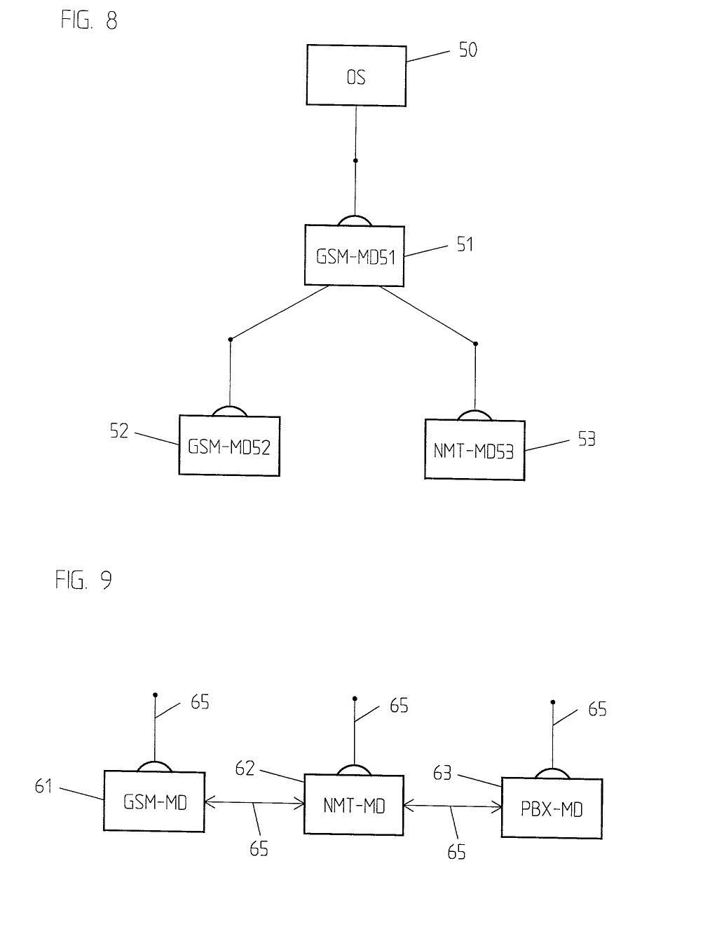

In FIG. 8 and FIG. 9 an operations system OS 50 is illustrated in a simplified manner which controls hierarchically arranged mediating devices, such as for example a GSM-MD 51 which controls a GSM-MD 52 and a NMT-MD 53.

FIG. 9 shows a number of MDs arranged in a flat structure in which a GSM-MD 61 communicates via an extended interface 65 with a NMT-MD 62 which in turn communicates via the extended interface 65 with a PBX-MD 63.

A new MD can be arranged anywhere in a flat structure or anywhere from a hierarchical point of view.

It is an advantage of the invention that the overhead caused by the re-routing of messages or management operations is small since each node only takes a peak of the message. Furthermore, according to an advantageous embodiment, each channel is synchronous which gives a deterministic system which enables an easy creation of traffic performance models. However, this relates to an advantageous embodiment; the invention also cover cases with asynchronous channels. Then, however, buffering has to be planned and provided for.

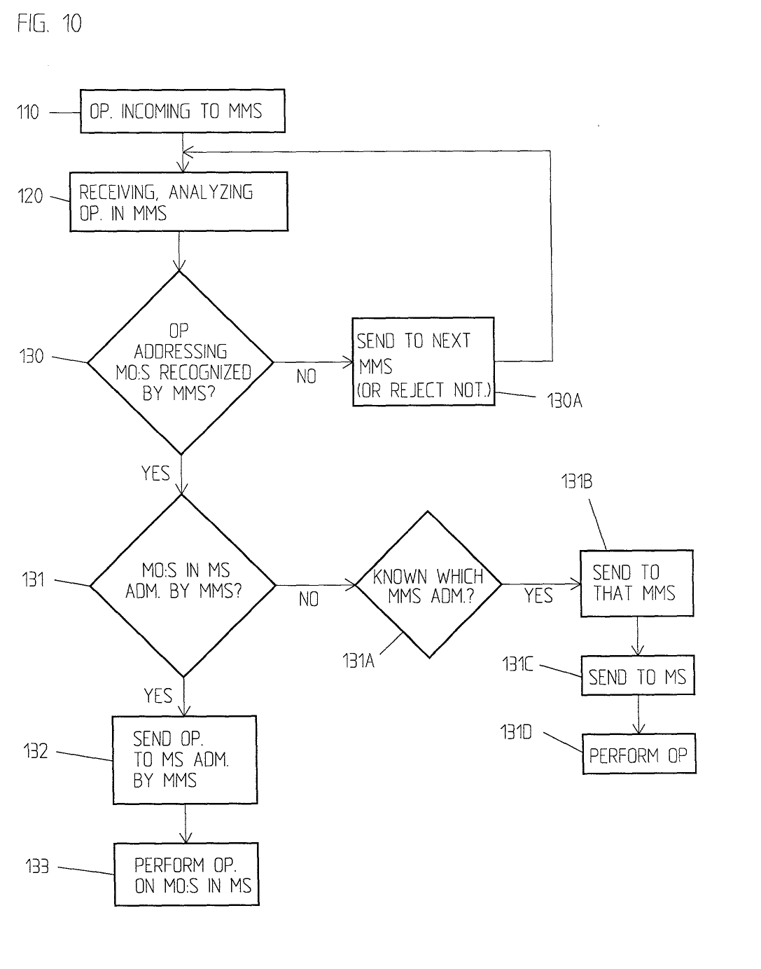

In FIG. 10 a flow diagram schematically illustrates the reception of a management operation incoming to a mediating managed system MMS, 110. After receiving of the operation in MMS, 120, it is examined, as described earlier in the application with the use of the routing function DNF, DNF-tables etc., if the management operation addresses MOs or MO instances which are recognized by the MMS, 130. If yes, it is established whether the MO instances are administrated by the MMS, 131. If however the addressed MOs or MO instances are not recognized, the operation is sent to the next (or another) mediating managed system, 130A. This may for example be a neighbouring MMS. Alternatively, in an embodiment in which e.g. the MMS keeps information about all MO:s, and the specific ones addressed by the operation, a reject notification may be dispatched to the managing system. Then the procedure as described above is repeated in this latter MMS. More generally one or more mediating systems may be instructed just to reject operations addressing unrecognized MO:s. Also, if no “target” MMS can be found, the operation is normally rejected.

If the MOs are not administrated by MMS, but the administrating MMS is known, 131A, the management operation is sent to that MMS, 131B, and the operation is sent to the relevant MS, 131C and the operation is performed, 131D, on the MOs. However, if it was detected that the MOs are administrated by the first receiving MMS, the operation is sent to the managed system MS administrated by that MMS, 132, and the operation is performed on the MOs or MO instances in that MS, 133.

According to an advantageous embodiment a protocol is implemented which supports CMISE services, (for example CAI which is a CMISE-like protocol with ASCII-coded MOs) or some other interface (e.g. CMISE-like) can be used and provided with the extended functionality. In one embodiment the management interface is described with the use of standard ASN.1 (Abstract Syntax Notation One, which is a standardized flexible notation allowing the definition of a variety of data types from simple types such as integers and bit strings to structured types such as sets and sequences as well as complex types defined in terms of others). It is for example described in ITU-T X.710, CMISE, Common Management Information Service and X.208, Specification of Abstract Syntax Notation One which are incorporated herein by reference.

In an advantageous embodiment there are multiple management interface channels between one or several mediating managed systems or mediation devices.

Advantageously there is provided for a consistency check and configuration possibility between several mediating managed systems (particularly mediation devices) using the management interface as a communication channel between the mediating managed systems comprising new dedicated MOs for DNF configuration. This e.g. enables automatical generation of agent codes.

It is an advantage of the invention that a homogeneous interface towards the customers can be presented irrespectively of which is the technology, e.g. of which mobile communications system etc. It is also an advantage that a gateway product is provided allowing a high degree scalability concerning performance and functionality. Synchronous communication, parallel sessions and redundant routes can be used. Still further it is an advantage that a product, i.e. a mediating managed system or a mediation device can be shared between different organizations, different operators etc., thus facilitating product handling, design, coordination etc. It is also an advantage that different functionalities can be implemented in old or new products without affecting the end customer, the managing system.

Another advantage of the invention is that it provides a most flexible configuration which is adaptable to the needs of the customers, that (new) functionalities etc. can be introduced when there actually is a need therefore (and not when the managing system is ready to do so) and which can be extended freely in any manner.

The invention is not limited to the illustrated embodiments but can be varied in a number of ways without departing from the scope of the claims.

What is claimed is:

1. A system comprising at least one managing system managing a number of managed systems, said managed systems comprising a number of managed objects (MO) representing a number of resources, via a number of mediating managed systems, a management interface providing communication between managing and (mediating) managed systems, on which management interface management operations addressing managed objects are sent from the managing system(s) to the mediating managed system(s),
wherein the management interface furthermore supports communication between a number of mediating managed systems and wherein a management operation received in a mediating managed system addressing one or more managed objects not recognized by, or not administrated by, said mediating managed system, is routed to at least one other mediating managed system.

2. The system of claim 1,
wherein one mediating managed system administrates a number of managed objects or one or more managed systems and/or one or more function blocks within a number of managed systems.

3. The system of claim 2,
wherein the managing system is not aware of to which mediating managed system a management operation is sent and/or routed.

4. The system of claim 1,
wherein at least a number of mediating systems provide access to all the functionalities (i.e. any managed object) supported by the totality of managed systems.

5. The system of claim 1,
wherein each managed object is given a distinguished name which is unique within the system and at least one instance name which is unique within the managed system to which it belongs, the distinguished name (DN) comprising the instance name and the name/address of the managed system.

6. The system of claim 5,
wherein each mediating managed system comprises a detecting and routing function (DNF).

7. The system of claim 6,
wherein the routing function (DNF) of a mediating managed system at least keeps information about which managed objects are comprised in or administrated by the mediating managed system.

8. The system of claim 7,
wherein the routing function of a mediating managed system keeps information about the types and of the instance names of the managed objects administrated by the mediating managed system.

9. The system of claim 7 or 8,
wherein at least some mediating managed systems only keep information about the managed object(s) contained in the mediating managed system(s) or in a managed systems administrated thereby, and if an operation is received which is directed to one or more managed objects which are not administrated by the receiving mediating managed system, the operation is routed to another mediating managed system.

10. The system of claim 6,
wherein the routing function of one or more mediating systems keep(s) information about at least some managed objects not administrated by the mediating system itself and wherein operations addressing such managed objects are routed towards the mediating managed system administrating or controlling such managed objects whereas operations addressing unrecognized managed objects are routed to another mediating managed system using default routing.

11. The system of claim 6,
wherein the routing functions of all mediating managed systems keep information about all managed objects of the system and wherein the information is consistent throughout the mediating managed systems of the system.

12. The system of claim 11,
wherein an operation addressing a managed object that cannot be identified by the receiving mediating managed system, is rejected and returned to the sending system.

13. The system of claim 1,
wherein additional mediation managed systems can be added to the system without requiring updating of the other mediating managed systems.

14. The system of claim 10,
wherein an operation addressing an unrecognized managed object(s) is consecutively sent from one mediating managed system to another via default routing until a mediating managed system is found which recognizes/administrates the addressed managed object(s) unless a mediating managed system is instructed to reject operations addressing unrecognized managed objects or no mediating managed system can be found which administrates the addressed managed object(s).

15. The system of claim 1,
wherein each mediating managed system comprises an agent for each of a number of types of managed objects managed by said mediating managed system, via which the managed objects are manipulated by the managing system.

16. The system of claim 1,
wherein a number of mediating managed systems are arranged in one and the same hierarchical layer.

17. The system of claim 1,
wherein at least one mediating managed system is a superior mediating managed system to a number of subordinate mediating managed systems.

18. The system of claim 1,
wherein the routing function of a number of mediating managed systems support(s) at least two routing alternatives, e.g. a primary and a secondary route to another mediating managed systems.

19. The system of claims 6 and 15,
wherein the routing functions keep type information of managed objects and instance information and in that type and instance information is used to select an agent in order to provide for load-sharing between mediating managed systems.

20. The system of any one of the preceding claims,
comprising a Telecommunications Management Network, the managing system(s) comprising operations systems; the managed systems comprising Network Elements and the mediating managed systems comprising mediating devices either comprising a Network Element or being used as a Network Element protocol, the management interface being of CMISE type, supporting at least a number of CMISE-services.

21. The system of claim 20,
wherein a mediation device, in addition to an agent for the detecting and routing functionality, comprises an agent for one or more Network Elements.

22. The system of claim 20,
comprising mediation devices dedicated for a number of telecommunications systems.

23. The system of claim 20,
wherein the managing system is an administration system and the management interface comprises a Customer Administration Interface with an extended functionality to provide communication between mediation devices.

24. A mediating managed system for administrating a number of resources represented by managed objects to which management operations are sent over a management interface, comprising a routing function for routing incoming management operations addressing managed objects which are not administrated by the mediating managed system, to another mediating managed system.

25. The system according of claim 24,
wherein the routing function at least comprises a table or a list of managed object types managed by the mediating device.

26. The system of claim 25,
wherein the routing function further comprises information about a number of other managed objects and wherein controlled routing is performed, for operations directed to such managed objects, to a mediating system administrating such managed object(s), whereas default routing is used for operations addressing unknown managed objects.

27. A system including a number of mediating systems, each for administrating a number of resources represented by managed objects to which management operations are sent over a management interface, each comprising a routing function for routing incoming management operations addressing managed objects which are unknown to the mediating managed system, to another mediating managed system,
wherein the mediating systems are interconnected so as to form a network of mediating systems and wherein the management interface providing for communication between a managing system and said mediating systems comprises the additional functionality of providing communication between mediating managed systems.

28. The system of claim 27,
wherein the management interface supports CMISE-services.

29. A system comprising at least one managing system and a number of managed systems, said managed systems comprising a number of managed objects and wherein the managing system manages the managed system(s) by sending management operations to the managed systems via a number of mediating managed systems, each of which controls one or more managed systems, said operations being sent on a management interface,
wherein management operations addressing managed objects, which are not recognized by a mediating managed system receiving the operation, are routed by the receiving mediating managed system via default routing to another mediating managed system.

30. The system of claim 29,
wherein each mediating managed system comprises a routing function which keeps information at least about managed object types administrated by the respective mediating managed system, the management interface providing for communication also between mediating managed systems.

31. The system of claim 30,
wherein the routing function of a mediating managed system also keeps information about a number of managed objects comprised in managed systems which are not administrated by the mediating managed system itself and wherein operations addressing such managed objects are routed in a controlled manner to the mediating managed system administrating them.

32. The system of any one of claims 29-31,
wherein information about a number of managed objects is kept in at least two mediating managed systems to provide for redundancy.

33. A method of performing an operation on a number of managed objects in a managed system which is managed by a managing system, said managing system sending a management operation on a management interface, wherein the management interface provides communication between a managing system and a number of managed systems,
comprising the steps of:
receiving the operation in a mediating managed system;
examining in the receiving mediating managed system if the managed objects addressed by the management operation are contained in the mediating managed system or in a managed system administrated thereby;
if yes, performing the management operation on the addressed managed objects;
if not; routing the operation to another mediating managed system;
in said other mediating managed system repeating the above mentioned steps until a mediating managed system is found containing the managed object or administrating a managed system containing the addressed managed objects and then performing the operation,
if no such mediating system is found or if a mediating managed system is instructed to reject operations addressing unknown managed objects, rejecting the management operation.

34. The method of claim 33,
wherein at least a number of mediating managed systems also keep information about at least some other managed objects not administrated or managed thereby and further comprising the steps of:
establishing in a mediating system, the first or a subsequent, if it keeps information about the target mediating managed system, i.e. the mediating managed system containing or administrating the managed object(s) addressed by the operation; if yes,
routing the operation to the target mediating managed system, otherwise routing the operation via default routing to another mediating managed system, advantageously at least a primary and a secondary routing alternative being available.

35. The method of claim 33 or 34,
further comprising the steps of:
adding a mediating managed system without updating the other mediating managed systems;
providing communication between the added mediating managed system and the other mediating systems through a management interface with the extended functionality of providing communication between mediating managed systems.
